(19) United States
(12) Patent Application Publication
(10) Pub. No.: US 2017/0129128 A1
(43) Pub. Date: May 11, 2017

(54) Saw

(71) Applicant: Black & Decker Inc., New Britain, CT (US)

(72) Inventors: Matteo Mortaro, Marsciano (IT); Lucio Ginocchini, San Sisto (IT); Marcello Bettacchini, Ellera di Corciano (IT)

(21) Appl. No.: 15/333,342

(22) Filed: Oct. 25, 2016

(30) Foreign Application Priority Data
Nov. 5, 2015 (GB) 1519538.1
Nov. 19, 2015 (GB) 1520424.1

(51) Int. Cl. B27B 27/04; B23D 45/02

(52) U.S. Cl. CPC B27B 27/04; B23D 45/024

(57) ABSTRACT

A saw including a base assembly having a work surface, a cutting unit mounted on the base assembly capable of cutting a work piece located on the work surface, and a fixed fence mounted on the base assembly for supporting the work piece when it is being cut. The base assembly has a rib abutting the fixed fence, The fixed fence abuts against the rib in a direction of a force applied to the fixed fence by the work piece when it is being cut.

### FIELD OF THE INVENTION

The present invention relates to a saw having a fixed fence for supporting a work piece.

### BACKGROUND

Numerous types of saw comprise a base structure upon which a work piece is located in order for it to be cut. For example, on chop saws, miter saws, bevel saws, sliding saws and compound miter saws, the work piece is held stationary on the base while the saw blade is moved towards or across the base structure in order to cut the work piece located on it. On other types of saw, for example, a table saw or band saw, the work piece is slid across the base structure in order for it to engage with a cutting blade having an overall stationary position. In all of these types of saws, the position of the work piece is controlled by a fence which is attached to the base structure. Some fences are permanently fixed in a non-moveable manner to the base and are referred to as a “fixed fence.” Others are mounted in a moveable manner on the base structure so that their position can be adjusted and are known as a “moveable fence.”

The present invention relates to a fixed fence and the mechanism by which it is mounted to a base structure.

### BRIEF DESCRIPTION OF THE DRAWINGS

FIG. 1 shows a perspective view of a miter saw;

FIG. 2 shows a rear view of the base and fixed fence only according to the first embodiment;

FIG. 3 shows a front exploded view of the base and fixed fence;

FIG. 4 shows a rear view of part of the base and fixed fence; and

FIG. 5 shows a schematic diagram of a vertical cross section of part of a side portion of the fence with a recess according to a second embodiment;

FIG. 6 shows a rear view of the fence according to a third embodiment;

FIG. 7 shows a vertical cross section of a bolt which attaches the fence as shown in FIG. 6; and

FIG. 8 shows a schematic diagram of an exploded view of the bolt and the aperture through the side portion of the fence as shown in FIG. 7.

### DESCRIPTION

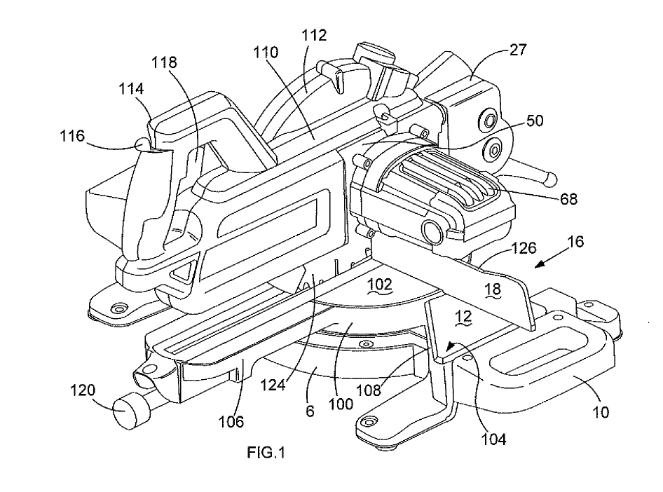

Referring to FIG. 1, the miter saw comprises a base assembly comprising a base 6 and a rotatable table 100. The base 6 preferably has two platforms 12 formed symmetrically on either side of the base 6. The rotatable table 100 is preferably rotatably mounted on the base 6 between the two platforms 12. The top surface 102 of rotatable 100 preferably lies flush with the top surfaces 104 of the two platforms 12. The combined surfaces 102, 104 of the rotatable table 100 and platforms 12, respectively, may form a work surface.

An extension arm 106 is rigidly attached to the rotatable table 100 which extends forward in well-known manner. The rotatable table 100 and extension arm 106 can pivot about a vertical axis through a range of angular positions. The angular movement is preferably restricted by the extension arm 106 engaging with one or other of the sides 108 of the platforms 12.

A locking lever 120 can be used to lock the rotatable table 100 and extension arm 106 in desired angular positions. A scale 122 is attached to the base 6 to indicate the angular position of the extension arm 106. Carrying handles 10 are attached to the sides of the base 6.

A mount 27 is preferably pivotally mounted on the rear of the rotatable table 100. Two guide rods (not shown) may be pivotally attached to the mount 27. A cutting unit 50 may be mounted to the mount 27 and/or slideably mounted on the two guide rods. Cutting unit 50 preferably includes a motor housing 68 in which is mounted an electric motor (not shown), guide rod support housing 110 in which are slideably mounted the two guide rods, and a blade guard 112 which surrounds a cutting blade 124 which is mounted on an output spindle (not shown) of the motor. The mount 27 can pivot about a horizontal axis on the rotatable table to enable the saw to perform bevel cuts. The rods can pivot on the mount about a horizontal axis to move the two rods and the cutting unit 50 vertically away from or towards the rotatable table 100 and extension arm 106 to enable the saw to perform chop cuts. A spring (not shown) preferably biases the mount 27 and guide rods to their highest position.

A handle 114 may be attached to the front of the cutting unit 50 by which a user moves the cutting unit 50 towards or away from the rotatable table 100 and extension arm 106. The mount 27 preferably locks in automatically its uppermost pivotal position by a latch mechanism (not shown). A pivotal lever 116 may be mounted on the handle 114 by which an operator can release the latch mechanism. A switch 118 is preferably mounted on the handle 114, the depression of which activates the electric motor.

A fixed fence 16 is preferably rigidly attached on top of the two platforms 12 of the base 6 at the rear of the platforms 12. The fence 16 preferably extends across the rotatable table 100 but does not interfere with its rotational movement.

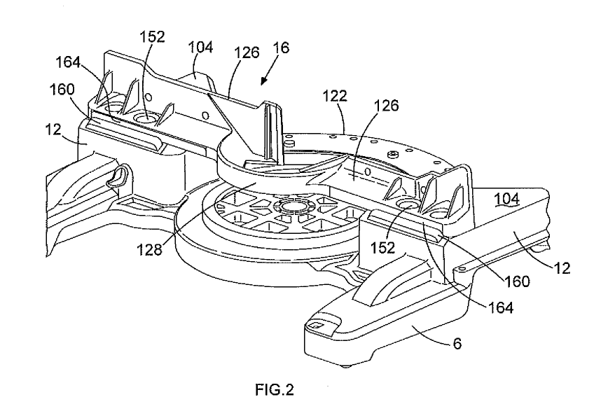

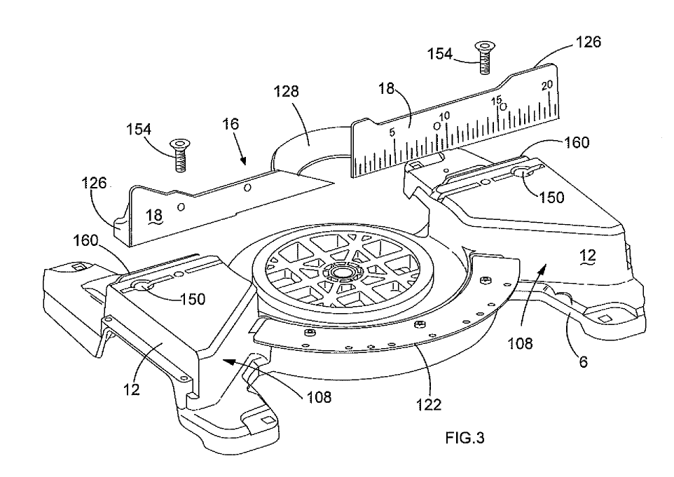

Referring to FIGS. 2 to 4, the fixed fence 16 may comprise two side portions 126, having flat faces 18, the planes of which are flush (i.e., co-planar) with each other. Side portions 126 may be attached to the platforms 12 and extend towards and partly over the rotatable table 100. Side portions 126 may be connected by a semi-circular portion 128 in well-known manner. The side portions 126 and semi-circular portion 128 are preferably manufactured in a one piece construction.

When the fixed fence 16 is mounted on the platforms 12, the vertical axis of rotation of the rotatable table 100 is preferably located in the plane of the faces 18 of the side portions 126. The center of the semi-circular portion 128 preferably aligns with the vertical axis of the rotatable table 100.

A threaded aperture 150 is preferably formed in the top of each platform 12. An aperture 152 may be formed through the rear of each side portion 126. When the fixed fence 16 is mounted on the platforms 12, each of the two apertures 152 preferably aligns with a threaded aperture 150. A threaded bolt 154 is preferably passed through each of the two apertures 152 and screwed into a threaded aperture 150 to secure the fixed fence 16 to the base 6.

During the use of the saw, a work piece is placed on the work surface 102, 104 and is placed against the flush surfaces of the side portions 126 of the fixed fence. After activating the motor to rotate the cutting blade 124, the cutting unit 50 is pivoted towards the work piece to engage the rotating cutting blade 124 with the work piece. As the cutting blade 124 cuts the work piece, it presses the work piece against the fixed fence 16 in a direction perpendicular to the plane of the flush surfaces of the side portions 126 of the fixed fence 16. The work piece in turn applies a force against the fixed fence 16 in the same direction. The cutting blade 124 cuts the work piece while it is pressed against the fixed fence 16.

The first embodiment of the present invention will now be described. An elongate rib 160 is preferably formed on the rear of each platform 12. Rib 160 preferably extends vertically upwards from the top surfaces 104 of the platforms 12 at the rear of the platforms 12. When the fixed fence 16 is mounted on the base, the ribs 160 locate against the rear wall 164 of the side portions 126 to locate the fence 16 in the correct position and prevent rearward movement while the fixed fence 16 is being attached to the base 6 and provide additional support against rearward movement of the fence 16 when the fixed fence 16 is being used.

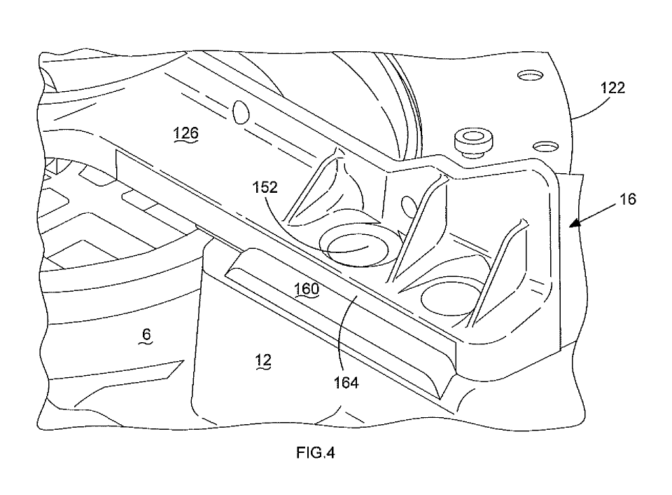

A second embodiment of the present invention will now be described with reference to FIG. 5. Where the same features are present in the second embodiment which were present in the first embodiment, the same reference numbers have been used. The second embodiment comprises elongate ribs 160 which are of the same design as in the first embodiment. Additionally, a recess 162 is preferably formed in each of the rear walls of the side portions 126 of the fixed fence 16. This recess 162 is preferably open rearwardly (direction A, parallel to the work surface) as well as downwardly (direction B, perpendicularly to the work surface).

Preferably the size of the recesses 162 correspond to the size of the ribs 160. When the fixed fence 16 is mounted on the base 6, the ribs 160 locate in and engage with the recesses 162 to locate the fixed fence 16 in the correct position while it is being assembled and provide additional support against rearward movement when the fixed fence 16 is being used. As the recesses 162 are preferably open rearwardly, the fixed fence 16 can be moved forward slightly during assembly to accommodate manufacturing tolerances.

It will be appreciated by a person skilled in the art that the recesses 162 can be replaced with grooves which only open downwardly.

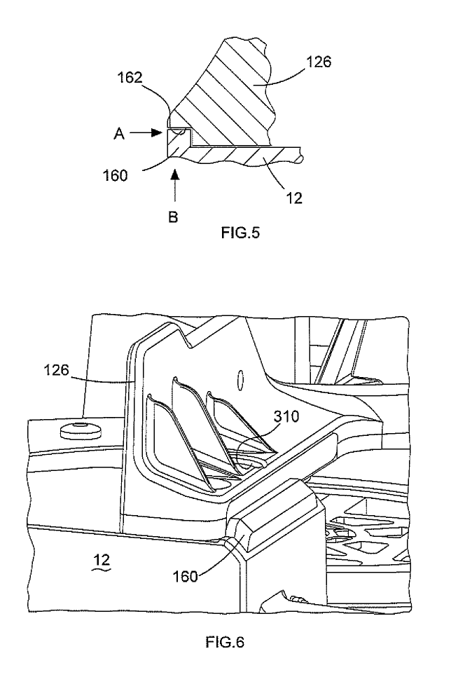

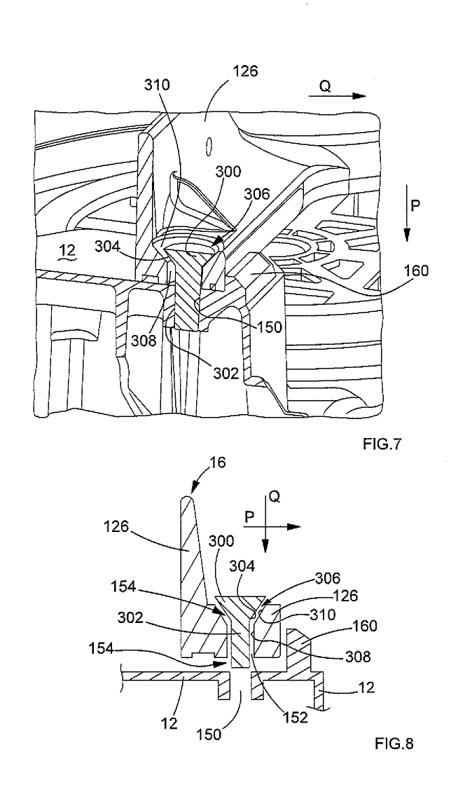

A third embodiment of the present invention will now be described with reference to FIGS. 6 to 8. Where the same features are present in the second embodiment which were present in the first embodiment, the same reference numbers have been used.

The difference between the third embodiment and the first embodiment is basically the design of the bolts 154 and the apertures 152 formed through the rear of each side portion 126 of the fixed fence 16. Preferably each bolt comprises a tapered head 300 which is attached to a threaded body 302. The tapered head 300 comprises an angled side wall 304. Each aperture 152 comprises a frusto-conical entrance 306 connected to a tubular section 308. The frusto conical entrance 306 comprises an angled wall 310. The dimensions of the angled wall 304 of the tapered head 300 and the angled wall 310 of the frusto-conical entrance 306 are substantially the same. When the fence 16 is attached to the base 6, the threaded body 302 of the bolt 154 is passed through the aperture 152 to threadedly engage the threaded aperture 150. The bolt 154 is then rotated, resulting the threaded body 302 of the bolt 154 screwing into the threaded aperture 150, the bolt 154 moving in the direction of Arrow P as it does so. As the bolt 154 screws into the threaded aperture 150, the angled side wall 304 of the tapered head 300 engages with the angled wall 310 of the frusto-conical entrance 306. As the bolt 154 continues to screw into the threaded aperture 150, the angled side wall 304 of the tapered head 300 and the angled wall 310 of the frusto-conical entrance 306 act as a cam and cam follower and slide along each other in order to move into alignment to allow the bolt 154 to continue to move in the direction of Arrow P. As the angled side wall 304 of the tapered head 300 aligns with the angled wall 310 of the frusto-conical entrance 306, the side portion 126 of the fixed fence 16 is urged in the direction of Arrow Q into engagement with the rib 160. As the bolt 154 is tightened, the side portion 126 of the fixed fence 16 is pushed against rib 160. When the bolt 154 is screwed to its maximum amount into the threaded aperture 150, the side portion 126 of the fixed fence 16 is held firmly against the rib 160.

While the present invention has been described in relation to a sliding compound miter saw, it will be appreciated that it is applicable to any saw which uses a fixed fence to support a work piece on a base such as a chop saw, a bevel saw, a table saw, a band saw, a slide saw or a radial arm saw.

1. A saw comprising:
a base assembly having a work surface;
a cutting unit mounted on the base assembly capable of cutting a work piece located on the work surface;
a fixed fence mounted on the base assembly for supporting the work piece when it is being cut;
wherein the base assembly has a first rib abutting the fixed fence.

2. The saw of claim 1 wherein the fixed fence abuts against the first rib in a direction of a force applied to the fixed fence by the work piece when it is being cut.

3. The saw of claim 1 wherein the base assembly comprises:
a base having first and second platforms, each platform having an upper surface;
a table rotatably mounted within the base between the two platforms, the table having an upper surface 102;
wherein the upper surfaces of the platforms and the table are co-planar to form the work surface.

4. The saw of claim 3 wherein the first platform supports the first rib.

5. The saw of claim 3 wherein the first rib is integrally formed on the first platform.

6. The saw of claim 1 wherein the fixed fence comprises a recess in which the first one rib locates when the fixed fence is attached to the base assembly.

7. The saw of claim 5 wherein the recess is open in both a rearward direction and a downward direction.

8. The saw of claim 1 wherein the fixed fence is mounted on the base assembly) by a fastener inserted into the base assembly to attach the fastener to the base assembly.

9. The saw of claim 8 wherein the fastener applies a biasing force to the fixed fence which urges the fixed fence into engagement with the first rib as the fastener is inserted into the base assembly.

10. The saw of claim 9 wherein the fastener extends through an aperture formed through the fence.

10. The saw of claim 11 wherein the fastener is a bolt with a tapered head.
